(19) United States
(12) Patent Application Publication
(10) Pub. No.: US 2026/0151965 A1
(43) Pub. Date: Jun. 4, 2026

(54) CLEANING MECHANISM AND 3D PRINTING DEVICE HAVING THE SAME

(71) Applicant: Shenzhen Creality 3D Technology Co., Ltd., Shenzhen (CN)

(72) Inventors: Dajiang Wu, Shenzhen (CN); Zhigong Liu, Shenzhen (CN); Jingke Tang, Shenzhen (CN)

(21) Appl. No.: 19/372,576

(22) Filed: Oct. 29, 2025

(30) Foreign Application Priority Data
Nov. 29, 2024 (CN) 202411757963.6

(51) Int. Cl. B29C 64/35; B33Y 40/00

(52) U.S. Cl. CPC B29C 64/35; B33Y 40/00

(57) ABSTRACT

The present application discloses a cleaning mechanism and a 3D printing device having the same. The cleaning mechanism is configured to clean a nozzle, and includes a first bracket, a driving member, a rotating member and a cleaning element. The driving member is slidably connected to the first bracket; the rotating member is rotatably connected to the driving member, the rotating member is configured to rotate as the driving member slides; the cleaning element is connected to the rotating member, the cleaning element is configured to clean the nozzle. The 3D printing device includes a bracket, a nozzle, a drive assembly and the cleaning mechanism, wherein the cleaning mechanism and the nozzle are respectively connected to the bracket, the nozzle is drivingly connected to the drive assembly, and the drive assembly drives the nozzle to contact or separate from the cleaning mechanism.

### FIELD

The present disclosure relates to field of 3D printing, and in particular to a cleaning mechanism and a 3D printing device having the same.

### BACKGROUND

3D printing technology is a rapid prototyping technology that manufactures three-dimensional objects by printing layer by layer of materials using special wax, powdered metal or plastic or other bondable materials based on digital model files. Fused deposition modeling technology is one of the main 3D printing technologies, which heats and melts thermoplastic filaments and extrudes them from a printing head, depositing them on a forming platform or a previously solidified material layer to eventually generate products. In existing 3D printing device, wherein filamentous printing material is fed into a heating head for heating and melting, and then extruded through a print head with a nozzle, allowing the printing material to cool and solidify to form products. However, during the process of extruding molten printing material, some printing material may remain at an extrusion end of the nozzle, possibly causing nozzle clogging and reduced printing precision.

Thus, there is room for improvement within the art.

### BRIEF DESCRIPTION OF THE DRAWINGS

Many aspects of the disclosure can be better understood with reference to the following drawings. The drawings in the following description are some embodiments of the present disclosure. For those of ordinary skill in the art, other drawings can be obtained based on these drawings without creative work.

FIG. 1 is a perspective view of a cleaning mechanism according to embodiments of the present application.

FIG. 2 is another perspective view of the cleaning mechanism according to embodiments of the present application.

FIG. 3 is an exploded perspective view of the cleaning mechanism according to embodiments of the present application.

FIG. 4 is a perspective view of a first bracket of the cleaning mechanism according to embodiments of the present application.

FIG. 5 is a perspective view of a part of the cleaning mechanism according to embodiments of the present application.

FIG. 6 is a perspective view of a part of the cleaning mechanism according to one embodiment of the present application.

FIG. 7 is a perspective view of a part of the cleaning mechanism according to another embodiment of the present application.

FIG. 8 is a side view of the cleaning mechanism according to another embodiment of the present application.

FIG. 9 is a perspective view of a 3D printing device according to embodiments of the present application.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it in one embodiment indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms "and/or" used herein includes any and all combinations of one or more of associated listed items.

Embodiments of the present application provide a cleaning mechanism and a 3D printing device having the same. The cleaning mechanism is configured to clean a nozzle. The cleaning mechanism includes a first bracket, a driving member, a rotating member and a cleaning element. The driving member is slidably connected to the first bracket; the rotating member is rotatably connected to the driving member, the rotating member rotates as the driving member slides; the cleaning element is connected to the rotating member and configured to clean the nozzle. The 3D printing device includes a frame, a nozzle, a drive assembly and the cleaning mechanism, wherein the cleaning mechanism and the nozzle are respectively connected to the frame, the nozzle is connected to the drive assembly, and the drive assembly drives the nozzle to contact or separate from the cleaning mechanism.

In the cleaning mechanism and 3D printing device of the present application, the driving member is slidably connected to the first bracket, enabling the driving member to slide under a drive (for example, being pushed by the nozzle); when the driving member moves relative to the rotating member, the driving member drives the rotating member to rotate, causing the rotating member to move closer to or away from the nozzle after being driven to rotate; the cleaning element is connected to the rotating member and disposed facing the nozzle, thereby enabling the cleaning element to move relative to the nozzle as the rotating member rotates, and contact the nozzle to clean it. The cleaning mechanism of the present application achieves rotation of the cleaning element for removing obstructions (such as residual materials) through the cooperation of the driving member and rotating member, without need for complex driving settings, furthermore, the rotating member drives the cleaning element to clean the nozzle in a rotating manner, making removal of residual materials around the nozzle more thorough.

As those skilled in the art can understand, "3D printing" refers to a technology that constructs objects layer by layer based on digital model files, using powdery metals or plastics and other bondable materials.

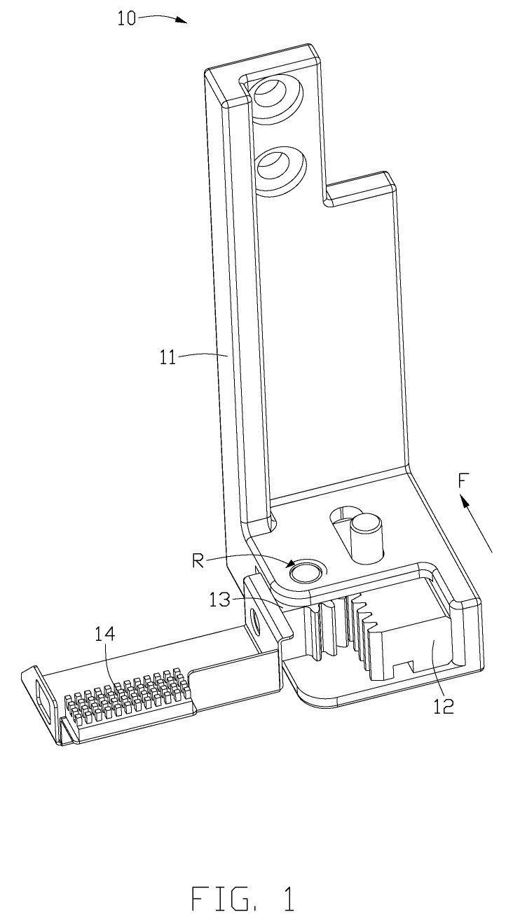

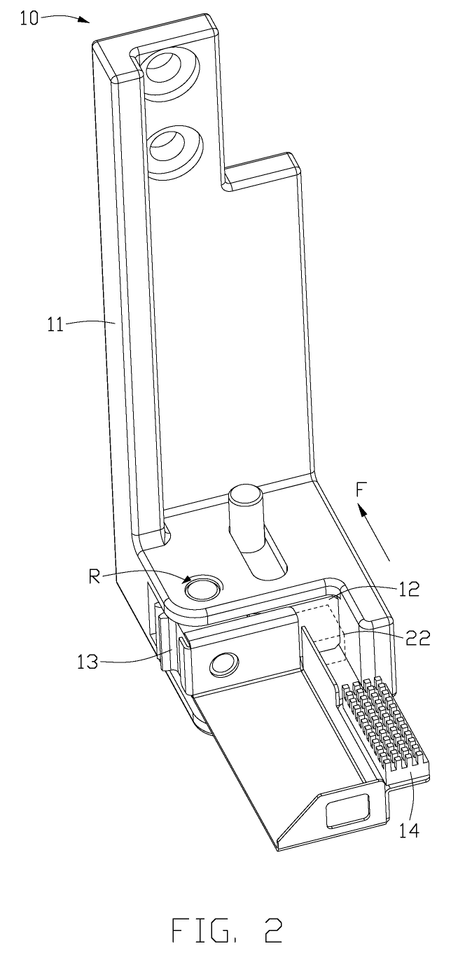

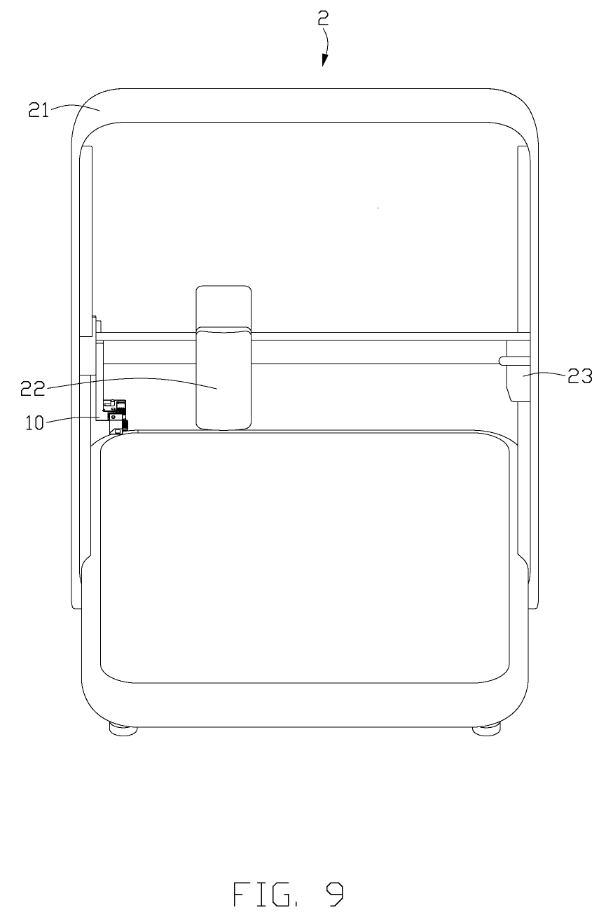

As shown in FIG. 1 to FIG. 3, embodiments of the present application provide a cleaning mechanism 10 for cleaning a nozzle 22. The cleaning mechanism 10 includes a first bracket 11, a driving member 12, a rotating member 13, and a cleaning element 14. The cleaning element 14 is connected to the rotating member 13 and can move along with the rotating member 13, the rotating member 13 and the driving member 12 are mounted on the first bracket 11 and can move relative to the first bracket 11, and the first bracket 11 enables the cleaning mechanism 10 to be installed on a 3D printing device 2 (as shown in FIG. 9).

In one embodiment, the driving member 12 is slidably connected to the first bracket 11; the rotating member 13 is rotatably connected to the driving member 12 through teeth, the rotating member 13 is capable of rotating as the driving member 12 slides, to move closer to or away from the nozzle 22; the cleaning element 14 is connected to the rotating member 13, and the cleaning element 14 is disposed facing the nozzle 22 and is configured to clean the nozzle 22.

In the cleaning mechanism 10 and 3D printing device 2 of the present application, the driving member 12 is slidably connected to the first bracket 11, enabling the driving member 12 to slide under a drive (for example, being pushed by the nozzle 22); when the driving member 12 moves relative to the rotating member 13, the driving member 12 drives the rotating member 13 to rotate through teeth, causing the rotating member 13 to move closer to or away from the nozzle 22 after being driven to rotate. The cleaning element 14 is connected to the rotating member 13 and disposed facing the nozzle 22, thereby enabling the cleaning element 14 to move relative to the nozzle 22 as rotating member 13 rotates, and contact the nozzle 22 to clean it. The cleaning mechanism 10 of the present application achieves rotation of the cleaning element 14 for cleaning nozzle through the cooperation of the driving member 12 and rotating member 13, without need for complex driving settings, furthermore, the rotating member 13 drives the cleaning element 14 to clean the nozzle 22 in a rotating manner, making removal of residual materials around the nozzle 22 more thorough.

In one embodiment, the driving member 12 is slidably connected to the first bracket 11 along a pushing direction F, in response to an end of the driving member 12 away from the first bracket 11 receives an external force, the driving member 12 is moved along the pushing direction F and drive the rotating member 13 to rotate along a first rotation direction R until the cleaning element 14 contacting the nozzle 22. In an embodiment, the end of the driving member 12 away from the first bracket 11 is configured to be impacted by a shell of the nozzle 22, making the driving member 12 to move along the pushing direction F and drive the rotating member 13 to rotate along the first rotation direction R until the cleaning element 14 contacting the nozzle 22.

In one embodiment, the nozzle 22 is configured to move relatively to frame of the 3D printing device to achieve the 3D printing process, while the first bracket 11 of the cleaning mechanism 10 is fixed in the 3D printing device to avoid interference with the nozzle 22. The end of the driving member 12 away from the first bracket 11 is at an outer side of the cleaning mechanism 10, enabling the driving member 12 to be contacted and pushed by the nozzle 22, achieving movement of the cleaning element 14 without complex driving mechanisms.

After the nozzle 22 contacts the driving member 12, the nozzle 22 continues to move along the pushing direction F and pushes the driving member 12, making the driving member 12 to slide relative to the first bracket 11 along the pushing direction F. The rotating member 13 is rotatably connected to the driving member 12 through teeth. The rotating member 13 includes an engaging portion 131 facing the driving member 12. When the driving member 12 slides along the pushing direction F, movement of the rotating member 13 in the pushing direction F is converted into rotation of the rotating member 13 along the rotation direction R through the teeth, making the end of the rotating member 13 away from an engaging portion 131 to rotate toward the nozzle 22. During the process of pushing the driving member 12, the nozzle 22 comes closer to the cleaning mechanism 10, and the rotating member 13 drives the cleaning element 14 to rotate, enabling the cleaning element 14 to move until contacting the nozzle 22, thereby cleaning the nozzle 22 and removing residual materials from an bottom outlet of the nozzle 22, with the rotational cleaning method often providing better cleaning effects. The driving member 12 may be pushed along the pushing direction F until it is stopped by the first bracket 11, and the rotating member 13 can rotate relative to the driving member 12 along the rotation direction R by a certain angle (for example, about 90°), enabling the cleaning element 14 to be substantially parallel to the pushing direction F. Furthermore, the driving member 12 may be pushed by the nozzle 22 or other components mounted on the nozzle 22 (avoiding interference with the cleaning mechanism 10).

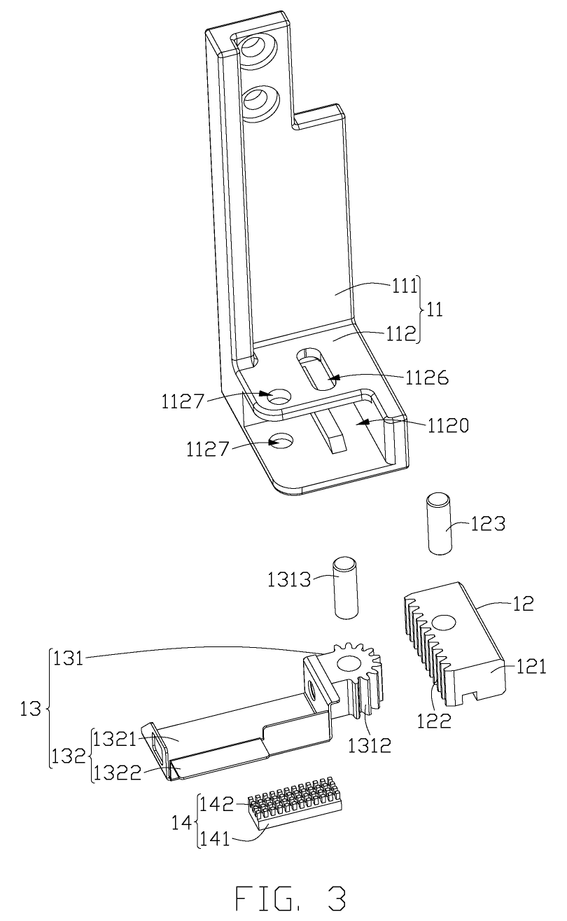

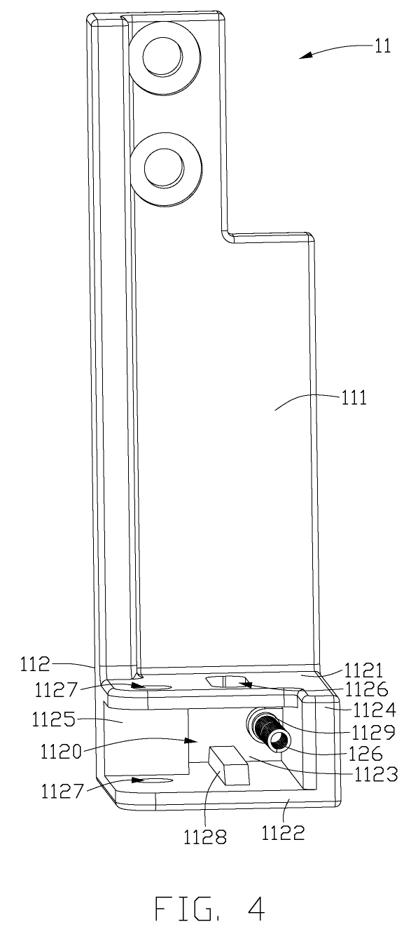

Referring to FIG. 3 and FIG. 4, in one embodiment, the driving member 12 includes first teeth 122 arranged in a strip shape, and the engaging portion 131 includes second teeth 1312 arranged in an arc shape. The first teeth 122 is meshed with the second teeth 1312.

In one embodiment, the strip-shaped first teeth 122 arranged along the pushing direction F, protrusions and recesses of multiple teeth on the first teeth 122 are arranged substantially perpendicular to the pushing direction F. The first teeth 122 are disposed on a side of the driving member 12 and face toward the rotating member 13. The second teeth 1312 are arranged on an outer side of the engaging portion 131, and are arranged substantially in a semicircular pattern. During the rotation of the rotating member 13, at least a part of the second teeth 1312 faces the driving member 12 and meshes with the first teeth 122, while other part of the second teeth 1312 is separated from the first teeth 122. Contacting portion between the second teeth 1312 and the first teeth 122 changes as rotation occurs.

In one embodiment, the first bracket 11 includes a connecting portion 111 and a mounting portion 112, the mounting portion 112 is connected at an end of the connecting portion 111. The mounting portion 112 is configured for mounting the driving member 12 and the rotating member 13. The mounting portion 112 includes a mounting cavity 1120 configured for receiving a part of the driving member 12 and a part of the rotating member 13. The connecting portion 111 is configured to connect with a frame 21 of the 3D printing device 2, and an end of the connecting portion 111 end away from the mounting portion 112 defines a mounting hole for connecting with the frame 21 of the 3D printing device 2.

In one embodiment, the mounting portion 112 includes a top plate 1121, a bottom plate 1122, an inner plate 1123, a first side plate 1124, and a second side plate 1125. The top plate 1121 and bottom plate 1122 are spaced apart and oppositely arranged, the first side plate 1124 and second side plate 1125 are spaced apart, and the inner plate 1123 is connected to the top plate 1121, bottom plate 1122, first side plate 1124, and second side plate 1125. The mounting portion 112 includes an opening on a side spaced apart from the inner plate 1123 along the pushing direction F, exposing the internal space of the mounting cavity 1120.

In one embodiment, the top plate 1121 includes a through groove 1126 and a through hole 1127. The through groove 1126 is elongated along the pushing direction F, and the through hole 1127 is approximately circular. The bottom plate 1122 includes another through hole 1127, which is also approximately circular. The two through holes 1127 correspondingly arranged. a guide strip 1128 is provided on the bottom plate 1122 and protrudes into the mounting cavity 1120, the guide strip 1128 extending along the pushing direction F. The through groove 1126 and guide strip 1128 are arranged corresponding to the position of the driving member 12 for cooperation with the driving member 12. The two limiting holes 1127 are arranged corresponding to the position of the rotating member 13 for cooperation with the rotating member 13.

In one embodiment, a length direction of the first side plate 1124 corresponds to the pushing direction F. The first side plate 1124 is connected to the top plate 1121, bottom plate 1122, and inner plate 1123, and is configured to limit the driving member 12. The second side plate 1125 is connected to the top plate 1121, bottom plate 1122, and inner plate 1123. The second side plate 1125 and the first side plate 1124 are located on a same side of the inner plate 1123. A length of the second side plate 1125 along the pushing direction F is shorter than a length of the first side plate 1124 along the pushing direction F. A portion of the rotating member 13 in the mounting cavity 1120 is between the top plate 1121, bottom plate 1122, and first side plate 1124.

In one embodiment, the inner plate 1123 includes a positioning post 1129 protruding into the mounting cavity 1120. The positioning post 1129 is arranged corresponding to the driving member 12 for cooperation with the driving member 12.

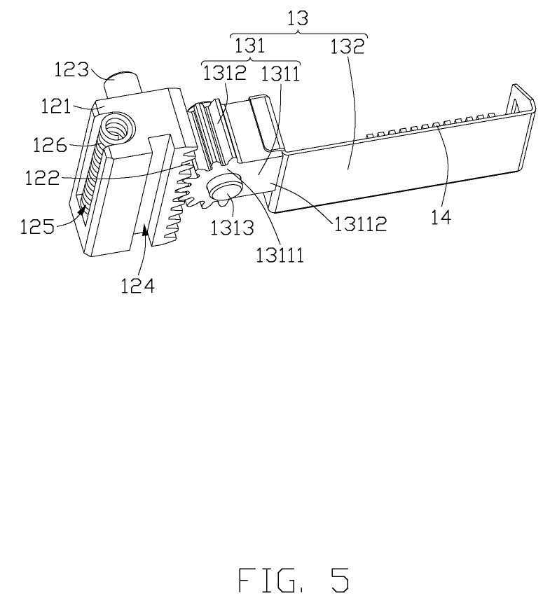

Referring to FIG. 3 and FIG. 5, in one embodiment, the driving member 12 further includes a first main body 121 and a first limiting post 123. The first teeth 122 are arranged on a side of the first main body 121, and the first limiting post 123 is connected to the first main body 121. The first limiting post 123 is slidably arranged in the through groove 1126, and the first main body 121 is slidably connected to the first bracket 11.

In one embodiment, the first main body 121 is substantially cuboid-shaped with multiple faces that respectively contact the top plate 1121, bottom plate 1122, and first side plate 1124. A guide groove 124 is defined on a side of the first main body 121 that contacts the bottom plate 1122, and the guide groove 124 is configured to receive the guide strip 1128. The first limiting post 123 is connected to a side of the first main body 121 that contacts the top plate 1121. The first limiting post 123 protruding relative to the first main body 121 and movably arranged in the guide groove 124 along the pushing direction F. A guide hole 125 is defined on a side of the first main body 121 that contacts the first side plate 1124. A length direction of the guide hole 125 is parallel to the pushing direction F. The guide hole 125 corresponds to the positioning post 1129 on the inner plate 1123. A reset member 126 is sleeved on the positioning post 1129, and an end of the reset member 126 abuts against the first main body 121 to push the driving member 12 to reset. The reset member 126 is received in the guide hole 125, and the first side plate 1124 cooperates with the guide hole 125 to limit the reset member. The end of the reset member 126 may abut against an inner wall of the guide hole 125 in the pushing direction F to push the driving member 12 to reset. The reset member 126 may be a spring or an elastic element. The first teeth 122 are disposed on the side of the first main body 121 away from the first side plate 1124, enabling the first teeth 122 face toward the rotating member 13.

The driving member 12 is disposed in the mounting cavity 1120 along the pushing direction F, with one end of the driving member 12 may contact the nozzle 22. The driving member 12 slides relative to the mounting portion 112 along the pushing direction F under the cooperation of the guide strip 1128 with the guide groove 124 and/or the first limiting post 123 with the through groove 1126, causing relative movement between the driving member 12 and the rotating member 13. As the driving member 12 moves toward the inner plate 1123 along the pushing direction F, the reset member 126 is compressed. When the force applied by the nozzle 22 to the driving member 12 decreases or is removed, the driving member 12 resets under the elastic force of the reset member 126, and correspondingly, the rotating member 13 also resets under the reset of the driving member 12.

In one embodiment, the rotating member 13 includes the engaging portion 131 and a second bracket 132. The engaging portion 131 is rotatably connected to the driving member 12 through the teeth, the second bracket 132 is connected to the engaging portion 131, the second bracket 132 is spaced apart from the first bracket 11, and the cleaning element 14 is connected to the second bracket 132. In one embodiment, the engaging portion 131 and the second bracket 132 may be integrally formed. In other embodiment, the engaging portion 131 and the second bracket 132 may be separately formed and connected to each other. The second bracket 132 is capable of moving along with the engaging portion 131 and drive the cleaning element 14 to move.

The second bracket 132 being spaced apart from the first bracket 11 means: the second bracket 132 is connected to the driving member 12 mounted on the first bracket 11 through the engaging portion 131, and the second bracket 132 is spatially spaced apart from and does not contact the first bracket 11. During a driven rotation of the second bracket 132, the second bracket 132 may maintain spacing from and avoid contact with the first bracket 11, thereby avoiding interference with the rotation of the rotating member 13 due to contact between the second bracket 132 and the first bracket 11.

In one embodiment, the engaging portion 131 further includes a second main body 1311 and a second limiting post 1313. The second teeth 1312 are disposed on a side of the second main body 1311 facing the first main body 121, the second limiting post 1313 is connected to the second main body 1311, the second limiting post 1313 is connected to the first bracket 11 through the through hole 1127, and the engaging portion 131 is rotatably connected to the first bracket 11.

In one embodiment, the second main body 1311 includes an arc-shaped connecting end 13111 and a transmission connecting end 13112. The arc-shaped connecting end 13111 and the transmission connecting end 13112 are integrally formed and connected to each other. The arc-shaped connecting end 13111 is at side of the second main body 1311 near the driving member 12, with the second teeth 1312 disposed on the side facing the driving member 12, and the second teeth 1312 are arranged along an arc-shaped side surface of the arc-shaped connecting end 13111. The arc-shaped connecting end 13111 is received in the mounting cavity 1120. The second limiting post 1313 extending through the arc-shaped connecting end 13111, and opposite ends of the second limiting post 1313 can be respectively disposed in the two limiting holes 1127, enabling the engaging portion 131 to rotate around the second limiting post 1313 along the rotation direction R. The transmission connecting end 13112 is connected between the arc-shaped connecting end 13111 and the second bracket 132.

In one embodiment, the second bracket 132 is connected to the transmission connecting end 13112 and extends away from the arc-shaped connecting end 13111. The second bracket 132 is configured to support the cleaning element 14 and maintain an appropriate relative position between the cleaning element 14 and the nozzle 22 for cleaning. The relative position between the cleaning element 14 and the nozzle 22 may be adjusted by adjusting a length or shape of the second bracket 132. The second bracket 132 includes a third main body 1321 and a supporting wall 1322. The second bracket 132 may be a sheet metal part, the third main body 1321 and supporting wall 1322 may be integrally connected. The third main body 1321 may be fixedly or movably connected to the transmission connecting end 13112. The supporting wall 1322 supports the cleaning element 14, and the supporting wall 1322 protrudes from a side of the third main body 1321 facing the nozzle 22, avoiding interference between the third main body 1321 and the nozzle 22.

In one embodiment, the cleaning element 14 includes a fourth main body 141 and a cleaning portion 142. The fourth main body 141 is connected to the supporting wall 1322, and the cleaning portion 142 is disposed on a side of the fourth main body 141 away from the supporting wall 1322. The fourth main body 141 is configured for achieving connection between the cleaning element 14 and the rotating member 13. The cleaning portion 142 includes multiple protrusions, giving the cleaning portion 142 an uneven structure for cleaning the nozzle 22. In other embodiments, the cleaning portion 142 may be a grid-like or other patterned structure, or the cleaning portion 142 may be a rotatable cylindrical structure with an adhesive surface that removes residual materials through contact adhesion.

The fourth main body 141 may be a rubber sheet with adhesion and/or elasticity. The cleaning portion 142 may be rubber protrusions that provide high friction for better cleaning and flexibility to avoid damage to the nozzle 22.

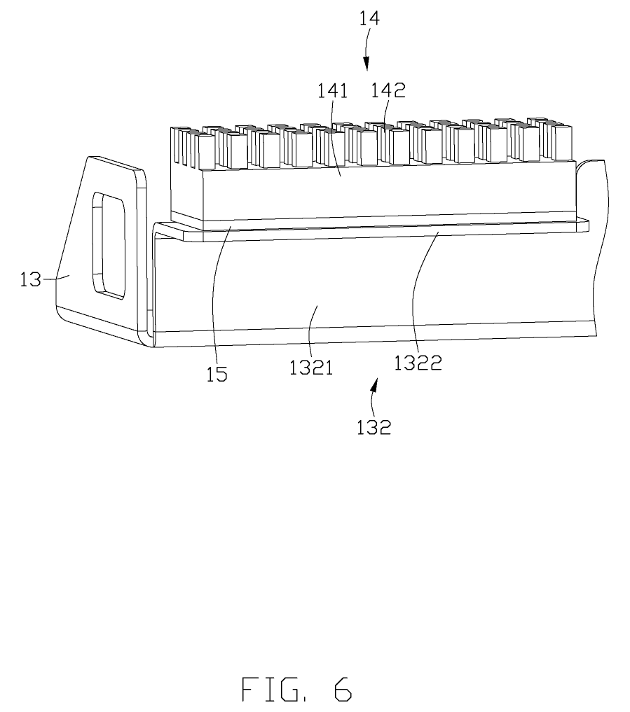

Referring to FIG. 6, in one embodiment, the cleaning mechanism 10 further includes an elastic member 15. The elastic member 15 is connected to the cleaning element 14 and the second bracket 132. The elastic member 15 causes the cleaning element 14 to move closer to or away from the second bracket 132.

In one embodiment, the second bracket 132 is fixedly connected to the engaging portion 131, and the elastic member 15 is arranged between the cleaning element 14 and the second bracket 132. The cleaning element 14 is connected to the second bracket 132 through the elastic member 15, and a distance between the cleaning element 14 and the second bracket 132 may decrease in response to the elastic member 15 elastically retract, and increase in response to the elastic member 15 elastically deforms.

In one embodiment, the elastic member 15 is a spring plate disposed between the fourth main body 141 and the supporting wall 1322. The position of the cleaning element 14 is slightly higher than the bottom outlet of the nozzle 22. When the cleaning element 14 contacts the bottom outlet of the nozzle 22, the cleaning element 14 and the nozzle 22 compress each other to enhance the pressure between them, thereby increasing friction and improving cleaning effectiveness. Meanwhile, the elastic member 15 arranged between the cleaning element 14 and the supporting wall 1322 provides space for the cleaning element 14 to yield. When the nozzle 22 compresses the cleaning element 14, the elastic member 15 contracts and reduces in thickness, allowing the cleaning element 14 to yield to the nozzle 22 to avoid jamming or damage, while the deformed elastic member 15 also applies a force toward the nozzle 22 on the cleaning element 14, enabling the cleaning element 14 to press against the nozzle 22 and improve cleaning effectiveness.

In other embodiments, the elastic member 15 may be other elastic structures that can contract, yield, and provide support, such as rubber sheets.

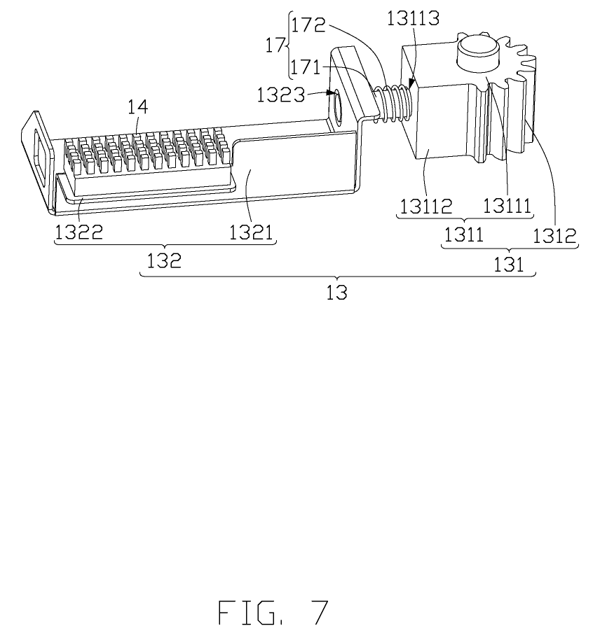

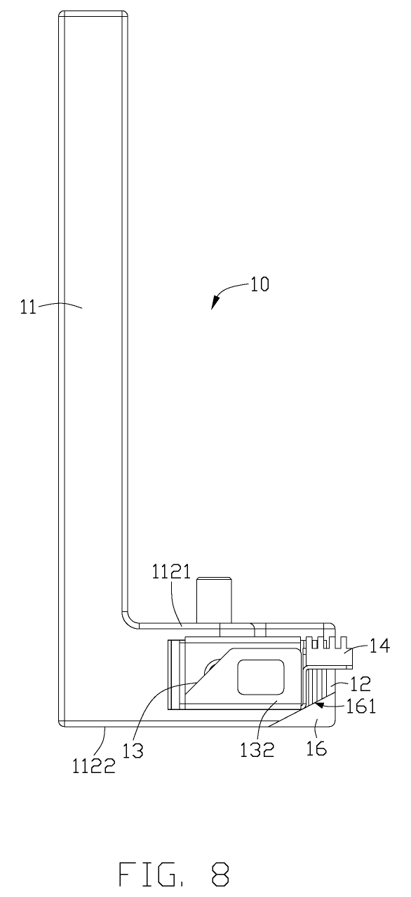

Referring to FIG. 7 and FIG. 8, in another embodiment, the cleaning mechanism 10 further includes a guide member 16. The guide member 16 is connected to the first bracket 11 and arranged on a rotation path of the rotating member 13. The guide member 16 is configured to change a rotation direction of the second bracket 132. The second bracket 132 detachably contacts the guide member 16, making the second bracket 132 to be guided by the guide member 16 to drive the cleaning element 14 to move closer to the nozzle 22.

In one embodiment, the second bracket 132 is rotatably connected to the engaging portion 131. The cleaning element 14 and the guide member 16 are respectively disposed on opposite sides of the second bracket 132. The guide member 16 includes an inclined guide surface 161. The second bracket 132 may contact the inclined guide surface 161 cause the second bracket 132 rotate and to move the cleaning element 14 towards a side away from the guide member 16. The inclined guide surface 161 extends from a side of the first bracket 11 close to the bottom plate 1122 toward a side of the first bracket 11 close to the top plate 1121, and the inclined guide surface 161 may be a extending inclined surface corresponding to the rotation direction R, making a lifting process of the second bracket 132 more natural and improving the cleaning effectiveness of the cleaning element 14 on the nozzle 22.

In one embodiment, the engaging portion 131 is connected to the second bracket 132 through a rotating connecting member 17, enabling the second bracket 132 to rotate relative to the engaging portion 131. A connecting cavity 13113 is defined on the transmission connecting end 13112 of the engaging portion 131, and a connecting opening 1323 is defined on the third main body 1321 of the second bracket 132. The rotating connecting member 17 includes a connecting shaft 171. The engaging portion 131 and the second bracket 132 are rotatable connected by the connecting shaft 171 extending through the connecting opening 1323 and further received in the connecting cavity 13113 The second bracket 132 is able to rotate relative to the engaging portion 131 around the connecting shaft 171.

Furthermore, the rotating connecting member 17 includes a reset portion 172. The reset portion 172 is sleeved on the connecting shaft 171 and is configured for resetting the second bracket 132. In one embodiment, the reset portion 172 can be a torsion spring. The torsion spring deforms under compression when the second bracket 132 rotates relative to the engaging portion 131, and releases elastic force to reset the second bracket 132 when the rotating force is removed. The reset portion 172 helps improve the reset precision of the second bracket 132. In other embodiment, the second bracket 132 may reset under gravity without the reset portion 172.

During the rotation of the rotating member 13 along the rotation direction R, the side of the second bracket 132 away from the cleaning element 14 abuts against the guide inclined surface 161. The guide inclined surface 161 guides the side of the second bracket 132 with the cleaning element 14 to lift toward the nozzle 22 during rotation, making the cleaning element 14 press against the nozzle 22. The cleaning element 14 and the nozzle 22 compress each other, enhancing pressure between them and thereby increasing friction and improving cleaning effectiveness.

Referring to FIG. 9, embodiments of the present application also provide a 3D printing device 2. The 3D printing device 2 includes a frame 21, a nozzle 22, a drive assembly 23, and the cleaning mechanism 10. The cleaning mechanism 10 and the nozzle 22 are respectively connected to the frame 21, the nozzle 22 is drivingly connected to the drive assembly 23, and the drive assembly 23 drives the nozzle 22 to contact or separate from the cleaning mechanism 10.

The frame 21 may be a gantry structure including a Z-axis, the cleaning mechanism 10 is fixed to the frame 21, and the drive assembly 23 may drive an assembly containing the nozzle 22 to impact the driving member 12.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A cleaning mechanism configured for cleaning a nozzle, comprising:
a first bracket;
a driving member slidably connected to the first bracket;
a rotating member rotatably connected to the driving member, the rotating member configured to rotate as the driving member slides; and
a cleaning element connected to the rotating member, the cleaning element configured to clean the nozzle.

2. The cleaning mechanism according to claim 1, wherein the rotating member comprises:
an engaging portion rotatably connected to the driving member through teeth;
a second bracket connected to the engaging portion and spaced apart from the first bracket; the cleaning element is connected to the second bracket.

3. The cleaning mechanism according to claim 2, wherein:
the cleaning mechanism further comprises an elastic member connected to the cleaning element and the second bracket; the elastic member causes the cleaning element to move closer to or away from the second bracket.

4. The cleaning mechanism according to claim 3, wherein:
the second bracket is fixedly connected to the engaging portion, the elastic member is arranged between the cleaning element and the second bracket;
the cleaning element is connected to the second bracket through the elastic member, a distance between the cleaning element and the second bracket decreases in response to the elastic member elastically retract, the distance between the cleaning element and the second bracket increases in response to the elastic member elastically deforms.

5. The cleaning mechanism according to claim 2, wherein:
the cleaning mechanism further comprises a guide member connected to the first bracket and arranged on a rotation path of the rotating member, the guide member is configured to change a rotation direction of the second bracket;
the second bracket detachably contacts the guide member.

6. The cleaning mechanism according to claim 5, wherein:
the second bracket is rotatably connected to the engaging portion, the cleaning element and the guide member are respectively disposed on opposite sides of the second bracket;
the guide member defines an inclined guide surface, the second bracket contacts the inclined guide surface to cause the second bracket rotate and to move the cleaning element towards a side away from the guide member.

7. The cleaning mechanism according to claim 2, wherein:
the driving member comprises first teeth arranged in a strip shape, the engaging portion comprises second teeth arranged in an arc shape, and the first teeth mesh with the second teeth.

8. The cleaning mechanism according to claim 7, wherein:
the driving member further comprises a first main body and a first limiting post, the first limiting post is connected to the first main body;
the engaging portion further comprises a second main body and a second limiting post, the second limiting post is connected to the second main body;
the first limiting post is slidably arranged relative to the first bracket, the second main body is rotatably connected to the first bracket through the second limiting post, the first main body and the second main body are connected through the first teeth and the second teeth.

9. The cleaning mechanism according to claim 8, wherein:
the first bracket comprises a through groove and a through hole that are spaced apart, the first limiting post is slidably arranged in the through groove, the first main body is slidably connected to the first bracket, the second limiting post is connected to the first bracket through the through hole, and the engaging portion is rotatably connected to the first bracket.

10. The cleaning mechanism according to claim 8, wherein:
the first teeth are disposed on a side of the first main body, and the second teeth are disposed on a side of the second main body facing the first main body.

11. The cleaning mechanism according to claim 1, wherein:
the driving member is slidably connected to the first bracket along a pushing direction, in response to an end of the driving member away from the first bracket receives an external force, the driving member is moved along the pushing direction and drive the rotating member to rotate along a first rotation direction.

12. The cleaning mechanism according to claim 1, wherein:
the first bracket comprises a connecting portion and a mounting portion, the mounting portion is connected at an end of the connecting portion, the mounting portion is configured for mounting the driving member and the rotating member;
the mounting portion comprises a mounting cavity configured for receiving a part of the driving member and a part of the rotating member.

13. The cleaning mechanism according to claim 12, wherein:
the mounting portion comprises a guide strip, the guide strip is in the mounting cavity and arranged on a bottom plate of the mounting portion;
a guide groove is defined on a side of the driving member contacting the bottom plate of the mounting portion, and the guide groove is configured to receive the guide strip.

14. The cleaning mechanism according to claim 12, wherein:
a guide hole is defined on the driving member;
the mounting portion comprises a positioning post protruding into the mounting cavity, the positioning post is arranged corresponding to the guide hole.

15. The cleaning mechanism according to claim 14, wherein:
a reset member is sleeved on the positioning post, and an end of the reset member abuts against an inner wall of the guide hole to push the driving member to reset.

1616 The cleaning mechanism according to claim 2, wherein:
a connecting cavity is defined on an end of the engaging portion, and a connecting opening is defined on the second bracket;
the engaging portion is connected to the second bracket through a rotating connecting member; the rotating connecting member comprises a connecting shaft, the engaging portion and the second bracket are rotatable connected by the connecting shaft extending through the connecting opening and further received in the connecting cavity.

17. The cleaning mechanism according to claim 16, wherein:
the rotating connecting member comprises a reset portion, the reset portion is sleeved on the connecting shaft and is configured for resetting the second bracket.

18. The cleaning mechanism according to claim 2, wherein:
the second bracket comprises a third main body and a supporting wall, the third main body is connected to the engaging portion, the supporting wall supports the cleaning element, and the supporting wall protrudes from at a side of the third main body facing the nozzle.

19. The cleaning mechanism according to claim 18, wherein:
the cleaning element comprises a fourth main body and a cleaning portion, the fourth main body is connected to the supporting wall, and the cleaning portion is disposed on a side of the fourth main body away from the supporting wall; the cleaning portion comprises multiple protrusions.

20. A 3D printing device, comprising:
a main bracket;
a nozzle;
a drive assembly; and
the cleaning mechanism according to claim 1, wherein the cleaning mechanism and the nozzle are respectively connected to the main bracket, the nozzle is drivingly connected to the drive assembly, and the drive assembly drives the nozzle to contact or separate from the cleaning mechanism.
